(19) United States
(12) Patent Application Publication
(10) Pub. No.: US 2025/0346313 A1
(43) Pub. Date: Nov. 13, 2025

(54) VEHICLE WITH REMOVABLE PIN FOR LIFT ASSEMBLY

(71) Applicant: Oshkosh Corporation, Oshkosh, WI (US)

(72) Inventors: Devin Rosencrance, Oshkosh, WI (US); Guido Ritelli, Oshkosh, WI (US); Tyler Walsh, Oshkosh, WI (US)

(73) Assignee: Oshkosh Corporation, Oshkosh, WI (US)

(21) Appl. No.: 19/086,489

(22) Filed: Mar. 21, 2025

Related U.S. Application Data
(60) Provisional application No. 63/643,608, filed on May 7, 2024.
(60) Provisional application No. 63/643,617, filed on May 7, 2024.
(60) Provisional application No. 63/643,653, filed on May 7, 2024.
(60) Provisional application No. 63/643,723, filed on May 7, 2024.
(60) Provisional application No. 63/643,541, filed on May 7, 2024.
(60) Provisional application No. 63/643,788, filed on May 7, 2024.
(60) Provisional application No. 63/643,627, filed on May 7, 2024.
(60) Provisional application No. 63/643,528, filed on May 7, 2024.
(60) Provisional application No. 63/643,631, filed on May 7, 2024.
(60) Provisional application No. 63/713,023, filed on Oct. 28, 2024.
(60) Provisional application No. 63/712,602, filed on Oct. 28, 2024.
(60) Provisional application No. 63/712,647, filed on Oct. 28, 2024.
(60) Provisional application No. 63/712,621, filed on Oct. 28, 2024.
(60) Provisional application No. 63/712,662, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. B62D 65/18

(52) U.S. Cl. CPC B62D 65/18

(57) ABSTRACT

A vehicle system includes a first vehicle and a second vehicle. The first vehicle includes a first drive motor configured to drive one or more of a first plurality of tractive elements to propel the first vehicle, and a first cradle configured to support a product at a first end thereof for movement. The second vehicle includes a second drive motor configured to drive one or more of a second plurality of tractive elements to propel the second vehicle, and a second cradle configured to support the product at a second end thereof for movement. The first vehicle and the second vehicle move the product via at least one of the first drive motor or the second drive motor.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

One embodiment relates to a vehicle system. The vehicle system includes a first vehicle and a second vehicle. The first vehicle includes a first chassis, a first plurality of tractive elements coupled to the first chassis, the first plurality of tractive elements configured to engage a ground surface to support the first vehicle, a first drive motor configured to drive one or more of the first plurality of tractive elements to propel the first vehicle, and a first cradle configured to support a product at a first end thereof for movement. The second vehicle includes a second chassis, a second plurality of tractive elements coupled to the second chassis, the second plurality of tractive elements configured to engage the ground surface to support the second vehicle, a second drive motor configured to drive one or more of the second plurality of tractive elements to propel the second vehicle, and a second cradle configured to support the product at a second end thereof for movement. The first vehicle and the second vehicle move the product via at least one of the first drive motor or the second drive motor.

Another embodiment relates to a method of transporting a product. The method includes providing a first vehicle including a first chassis and a first cradle configured to support the product for movement, the first cradle rotatable relative to the first chassis, providing a second vehicle including a second chassis and a second cradle configured to support the product for movement, the second cradle rotatable relative to the second chassis, placing a pin in a second aperture defined by the second cradle such that rotation of the second cradle relative to the second chassis is inhibited, and controlling at least one of the first vehicle or the second vehicle to transport the product in a first direction. When the pin is placed in the second aperture, the first vehicle and the second vehicle are in a first configuration in which the first vehicle is a front vehicle and the second vehicle is a rear vehicle.

Still another embodiment relates to a vehicle system. The vehicle system includes two vehicles and one or more processing circuits. Each vehicle includes a chassis, a plurality of tractive elements coupled to the chassis, the plurality of tractive elements configured to engage a ground surface to support the vehicle, a drive system configured to drive one or more of the plurality of tractive elements to propel the vehicle and steer one or more of the plurality of tractive elements to steer the vehicle, a platform defining a platform aperture, a cradle configured to support a respective end of a product for movement, the cradle rotatably coupled to the platform, a bracket coupled with the cradle and defining a bracket aperture, and a pin configured to be received in the platform aperture and the bracket aperture to inhibit rotation of the cradle relative to the platform. The one or more processing circuits are configured to monitor a position of the pin and control the drive system of at least one of the two vehicles based on the position of the pin. The two vehicles are configured to transition between a first configuration and a second configuration by moving the pin out of the platform aperture and the bracket aperture of a first vehicle of the two vehicles and into the platform aperture and the bracket aperture of a second vehicle of the two vehicles.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which.

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a perspective view of the vehicle of FIG. 3 and another vehicle cooperating to support a telehandler, according to an exemplary embodiment.

FIG. 10 is a side view of the vehicle of FIG. 3 and another vehicle cooperating to support a telehandler, according to an exemplary embodiment.

FIG. 11 is a perspective view of the vehicle of FIG. 3 including a rotation locking assembly in a first position, according to an exemplary embodiment.

FIG. 12 is a top view of the vehicle of FIG. 3 including the rotation locking assembly of FIG. 11 in the first position, according to an exemplary embodiment.

FIG. 13 is a bottom perspective view of the vehicle of FIG. 3 including a sensor monitoring a position of a pin of the rotation locking assembly of FIG. 11, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a vehicle that is utilized in a manufacturing line or process is shown. The vehicle includes a frame and a base assembly coupled to the frame. The base assembly is configured to couple various implements to the frame, and the implements facilitate positioning, supporting, and/or lifting of a component of a product (e.g., a telehandler or an axle assembly of a telehandler). In some embodiments, the implement includes a lift implement with a cradle that receives and supports the component of the product and a lift assembly coupled between the cradle and the base assembly. The lift assembly includes a platform to which the cradle is rotatably coupled to.

In some embodiments, a first vehicle and a second vehicle (that are substantially similar or identical to each other) cooperatively support the product for movement, and the front vehicle (e.g., the first vehicle or the second vehicle) may turn relative to the rear vehicle (e.g., the first vehicle or the second vehicle) via drive motors or a steering motor. As the front vehicle turns relative to the rear vehicle, the cradle of the front vehicle may rotate relative to the platform of the front vehicle and permit the two vehicles to turn. The first vehicle and the second vehicle each include a rotation locking assembly configured to selectively permit or inhibit rotation of the cradle relative to the platform based on which vehicle of the first vehicle or the second vehicle is the front vehicle. The rotation locking assembly includes a pin configured to extend within an aperture of a bracket coupled with the cradle and an aperture of the platform in a first position to inhibit rotation of the cradle relative to the platform. The pin is movable out of the first position (e.g., out of engagement with the cradle and the platform) to a second position to permit rotation of the cradle relative to the platform.

To transition from a first configuration in which the first vehicle is the front vehicle and the second vehicle is the rear vehicle to a second configuration in which the second vehicle is the front vehicle and the first vehicle is the rear vehicle, a pin of the first vehicle is transitioned from the second position to the first position and the pin of the second vehicle is transitioned from the first position to the second position. Similarly, to transition from the first configuration to the second configuration, the pin of the first vehicle is transitioned from the first position to the second position and the pin of the second vehicle is transitioned from the second position to the first position. Transitioning between the first configuration and the second configuration is advantageous in certain operational scenarios in which it is difficult or impossible (e.g., due to space constraints) to transition the front vehicle (e.g., turn the front vehicle and the rear vehicle supporting the product) from traveling in a first direction to traveling in a second direction opposite the first direction while remaining in one of the first configuration or the second configuration.

### Overall Vehicle

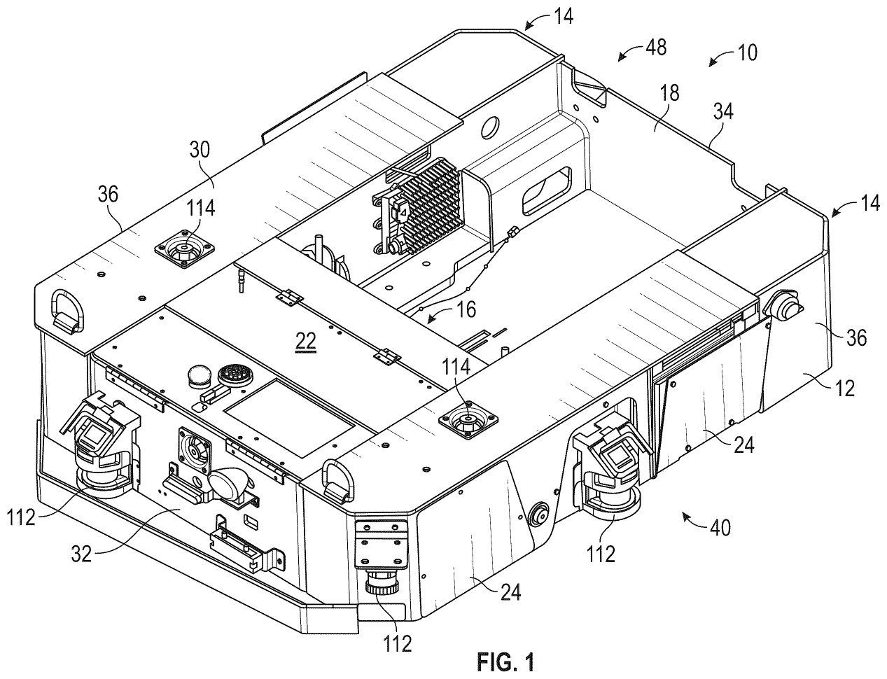

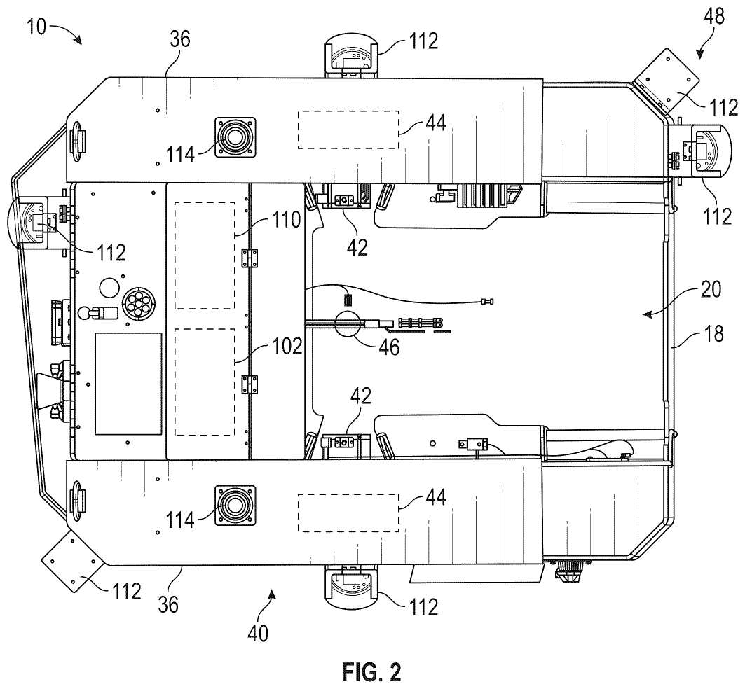

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

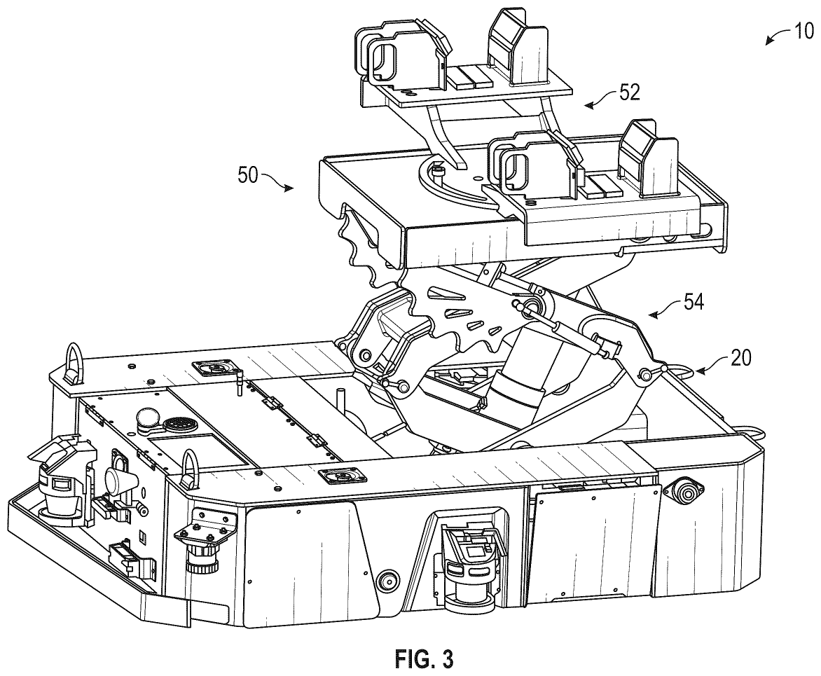

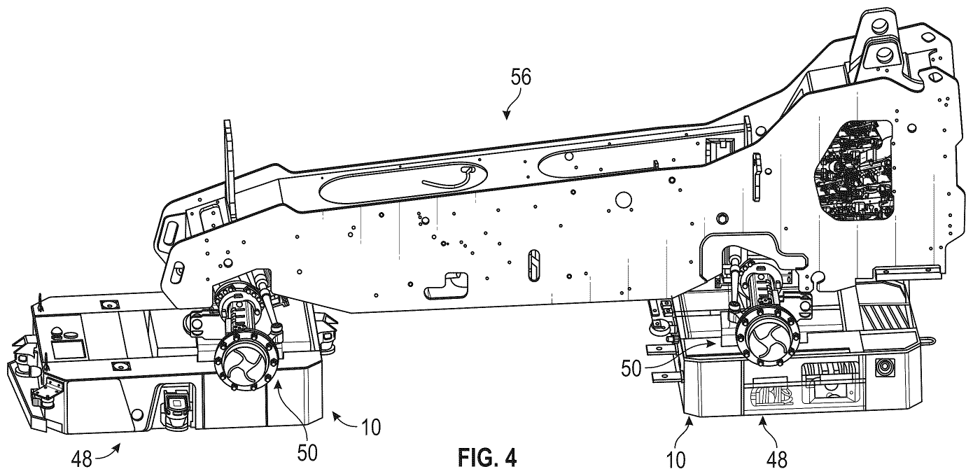

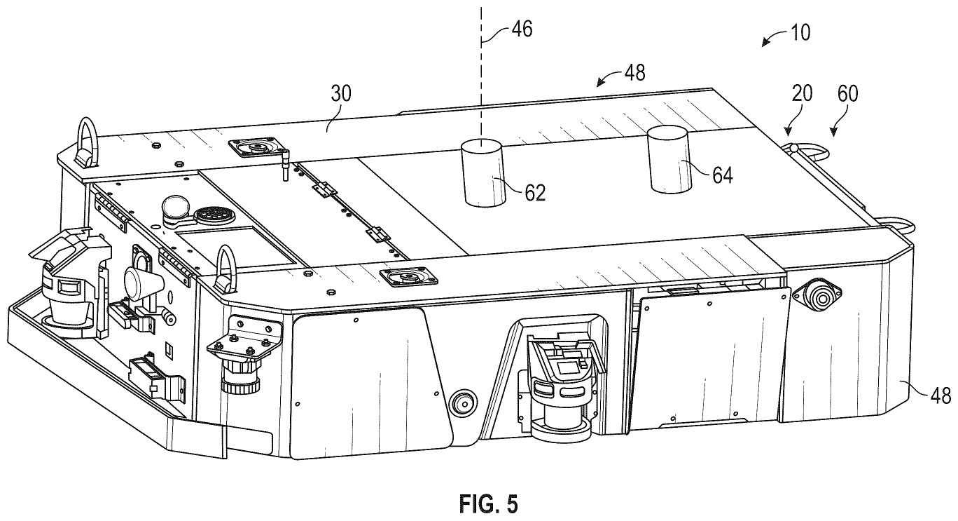

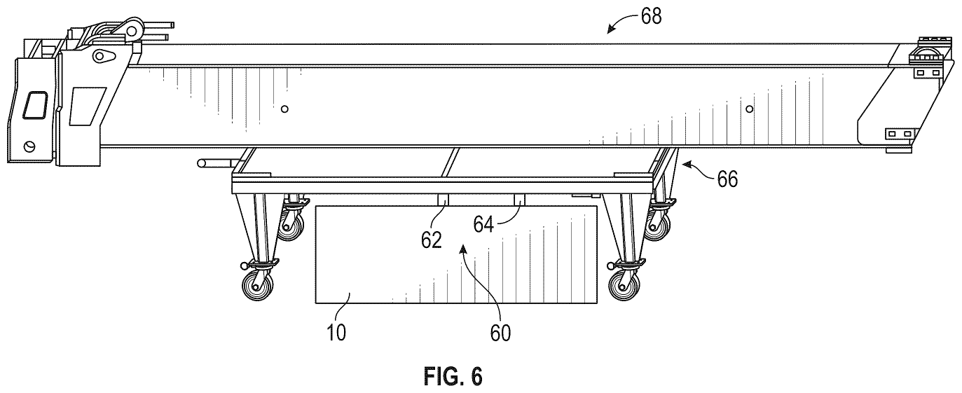

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

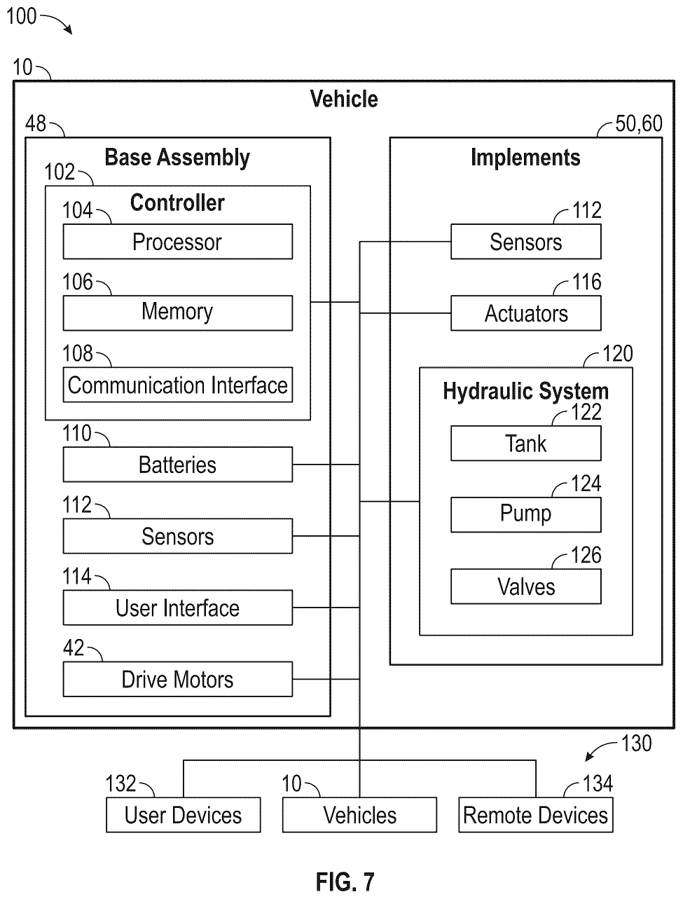

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

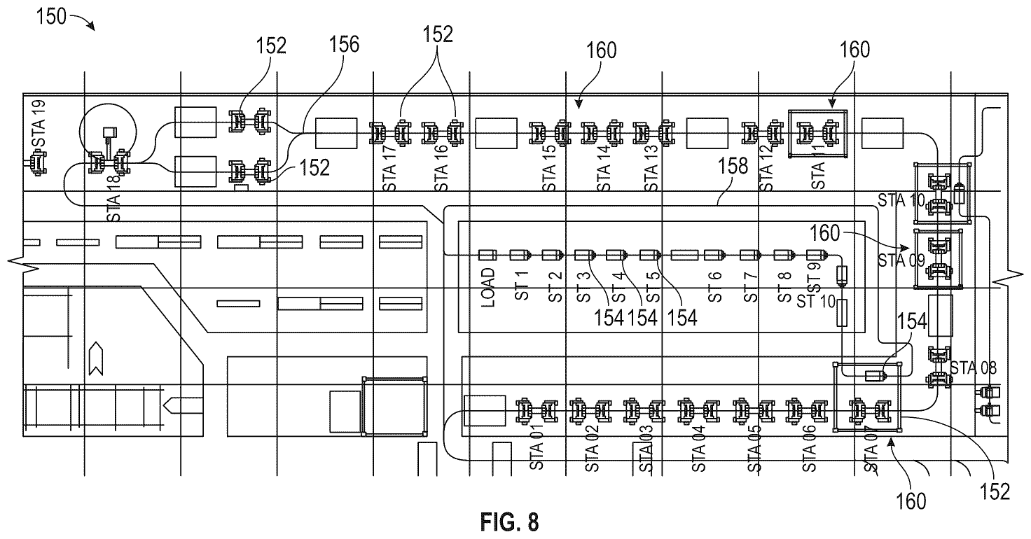

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Vehicle Coupling

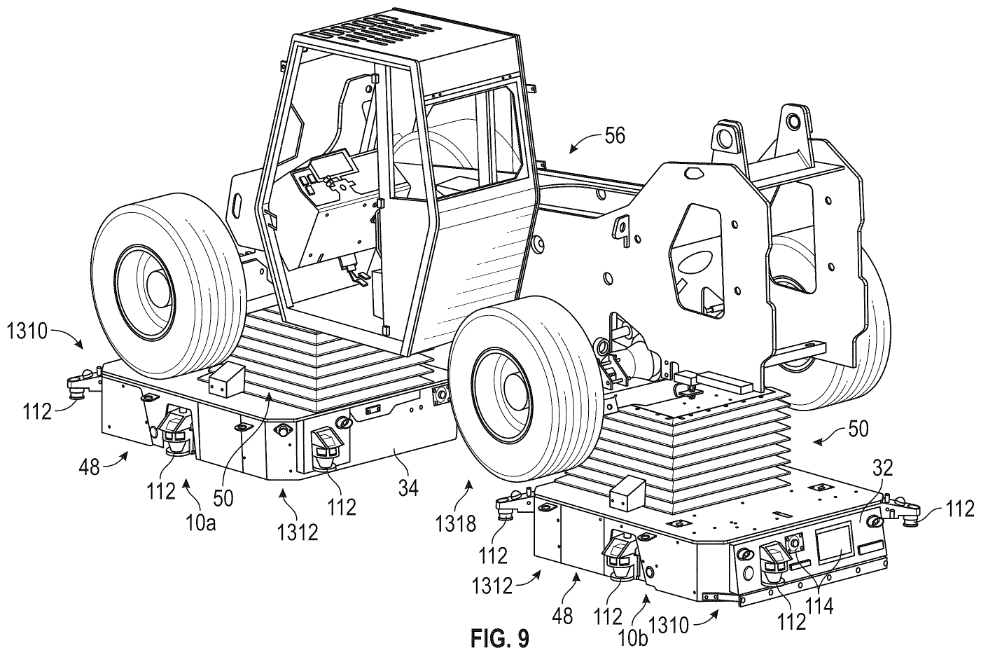

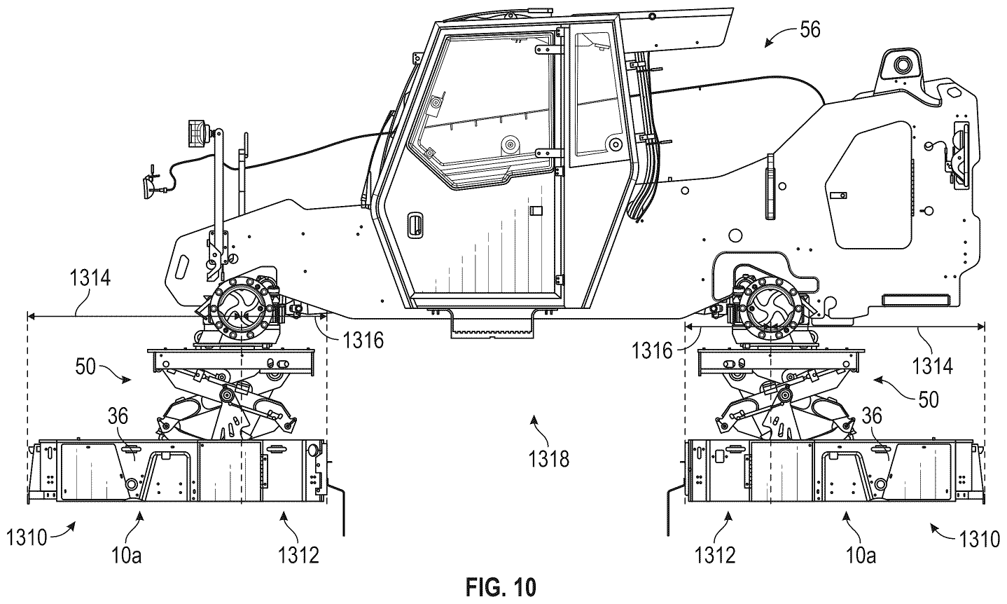

As shown in FIGS. 9 and 10, the vehicle 10 is a first vehicle 10a utilized with a second vehicle 10b to support a product such as the telehandler 56. The first vehicle 10a and the second vehicle 10b may cooperatively operate to facilitate moving the product, steering the product, and distributing the weight of the product during transportation. The first vehicle 10a and the second vehicle 10b may substantially similar and perform substantially similar operations. By way of example, each of the first vehicle 10a and the second vehicle 10b include a frame 12, a drivetrain 40, a base assembly 48, a lifting implement 50, and a control system 100.

According to an exemplary embodiment, any of the functions or processes described herein with respect to the first vehicle 10a may be performed by the second vehicle 10b. In such an embodiment, any of the functions or processes described herein with respect to the control system 100 of the first vehicle 10a may be performed by the control system 100 of the second vehicle 10b and/or one or more servers (e.g., remote devices 134). By way of example, data collection may be performed by the control system 100 of the first vehicle 10a and control over one or more components to move or steer the product may be performed by the control system 100 of the second vehicle 10b. By way of example, data collection may be performed by the control system 100 of the second vehicle 10b and control over one or more components to move or steer the product may be performed by the control system 100 of the first vehicle 10a. By way of still another example, a first portion of data collection may be performed by the control system 100 of the first vehicle 10a, a second portion of data collection may be performed by the control system 100 of the second vehicle 10b, and control over one or more components to move or steer the product may be performed by the control system 100 of the first vehicle 10a and/or the control system 100 of the second vehicle 10b.

As shown in FIGS. 9 and 10, the vehicle 10 defines a long side (e.g., first longitudinal side, a first portion of the base assembly 48, etc.), shown as first side 1310, and a short side (e.g., second longitudinal side, a second portion of the base assembly 48, etc.), shown as second side 1312. The first side 1310 defines a length (e.g., longitudinal length extending in a longitudinal direction), shown as first length 1314, from the front surface 32 to a center axis of an axle of the telehandler 56. The second side 1312 defines a length (e.g., longitudinal length extending in a longitudinal direction), shown as second length 1316, from the rear surface 34 to the center axis of an axle of the telehandler 56. According to an exemplary embodiment, the first length 1314 is greater than the second length 1316 such that the first side 1310 is longitudinally longer than the second side 1312 (e.g., the first side 1310 extends farther away from the lifting implement 50 than the second side 1312). In some embodiments, the first length 1314 is a length between the front surface 32 and a respective point (e.g., arbitrary location) along a longitudinal length of the vehicle 10 and the second length 1316 is a length between the rear surface 34 and the same respective point such that the first side 1310 is longitudinally longer than the second side 1312. In such embodiments, the respective point along the longitudinal length of the vehicle 10 is different than the center axis of an axle of the telehandler 56. By way of example, the respective point may be a location of the cradle 52.

As shown in FIGS. 9 and 10, the first vehicle 10a and the second vehicle 10b are collectively supporting the telehandler 56 and are longitudinally spaced apart by a distance such that the first vehicle 10a and the second vehicle 10b define a space 1318 therebetween. The first vehicle 10a is oriented in a first direction with the first side 1310 thereof away from the space 1318 (e.g., the front surface 32 facing away from the space 1318) and the second side 1312 thereof adjacent to the space 1318 (e.g., the second side 1312 of the second vehicle 10b being closer to the space 1318 than the first side 1310, the rear surface 34 facing the space 1318, etc.). The second vehicle 10b is oriented in a second direction opposite the first direction (e.g., 180 degrees about a vertical axis) with the first side 1310 thereof away from the space 1318 (e.g., the front surface 32 facing away from the space 1318) and the second side 1312 thereof adjacent to the space 1318 (e.g., the second side 1312 of the second vehicle 10b being closer to the space 1318 than the first side 1310, the rear surface 34 facing the space 1318, etc.). In other words, when the first vehicle 10a and the second vehicle 10b are collectively supporting the telehandler 56 and the first vehicle 10a and the second vehicle 10b are not being steered (e.g., traveling in a substantially straight direction, oriented substantially parallel with the telehandler 56, etc.) the first vehicle 10a and the second vehicle 10b are facing opposite directions (e.g., the second vehicle 10b is rotated about 180 degrees about a vertical axis relative to the first vehicle 10a).

With the first vehicle 10a and the second vehicle 10b oriented as shown and described, when the first vehicle 10a and/or the second vehicle 10b are steered to turn the product supported thereby, the first vehicle 10a does not contact the second vehicle 10b. By way of example, one or both of the first vehicle 10a or the second vehicle 10b were oriented with the first side 1310 positioned proximate the space 1318, when the first vehicle 10a and/or the second vehicle 10b are steered to turn the product, the first vehicle 10a and the second vehicle 10b may contact each other and potentially cause damage (e.g., scrapes, abrasions, dents, etc.) to each other. Further, with the first sides 1310 of the first vehicle 10a and the second vehicle 10b positioned away from the space 1318, the space 1318 is larger (e.g., compared to the space 1318 if one or both of the first vehicle 10a or the second vehicle 10b were oriented with the first side 1310 positioned proximate the space 1318) to provide access to a greater area of the bottom surface of the product.

As shown in FIG. 9, the user interface 114 is positioned at the first side 1310 along the front surface 32 of the vehicle 10. The first vehicle 10a and the second vehicle 10b are oriented with the first side 1310 and the front surface 32 facing outwards and away from the space 1318 such that an operator can access (e.g., provide inputs to, receive information from, etc.) the user interface 114 with out needing to enter the space 1318 between the first vehicle 10a and the second vehicle 10b and below the product supported thereby.

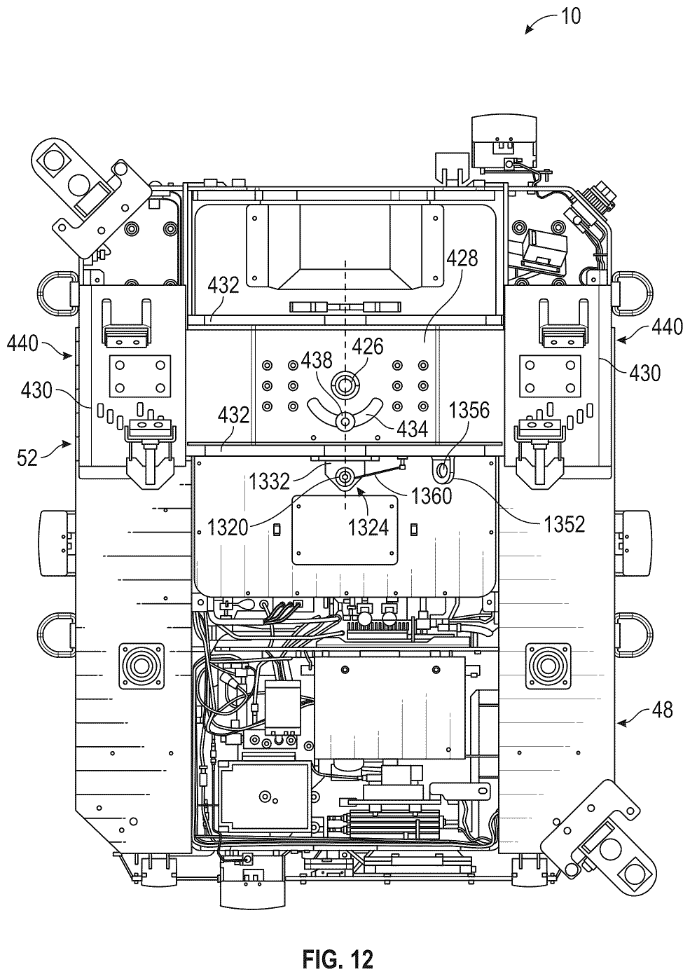

As shown in FIG. 12, and as discussed in greater detail above, the cradle base 428 includes the rotation slot 434 through which the pin 438 is received. The cradle base 428 is rotatable relative to the top platform 402 via the cradle pin 426 and the rotation slot 434 is arcuate to define a rotational range for the cradle base 428 to rotate in relative to the top platform 402. The ends of the rotation slot 434 serve as mechanical stops with which the pin 438 engages to inhibit rotation of the cradle base 428 beyond (e.g., outside of, past, etc.) the rotational range. The rotational coupling between the cradle 52 and the top platform 402 via the cradle pin 426 enables steering operation for the vehicle 10. The first vehicle 10a and the second vehicle 10b may support the telehandler 56 during the manufacturing line process, and the front vehicle 10 (e.g., the first vehicle 10a or the second vehicle 10b) may turn relative to the rear vehicle 10 (e.g., the first vehicle 10a or the second vehicle 10b) via the drive motors 42 or a steering motor. As the front vehicle 10 turns relative to the rear vehicle 10, the cradle 52, which supports the telehandler 56, of the front vehicle 10 may rotate relative to the top platform 402 of the front vehicle 10 and permit the two vehicles 10 to turn (e.g., the two vehicles 10 are not restricted to travel in a straight line).

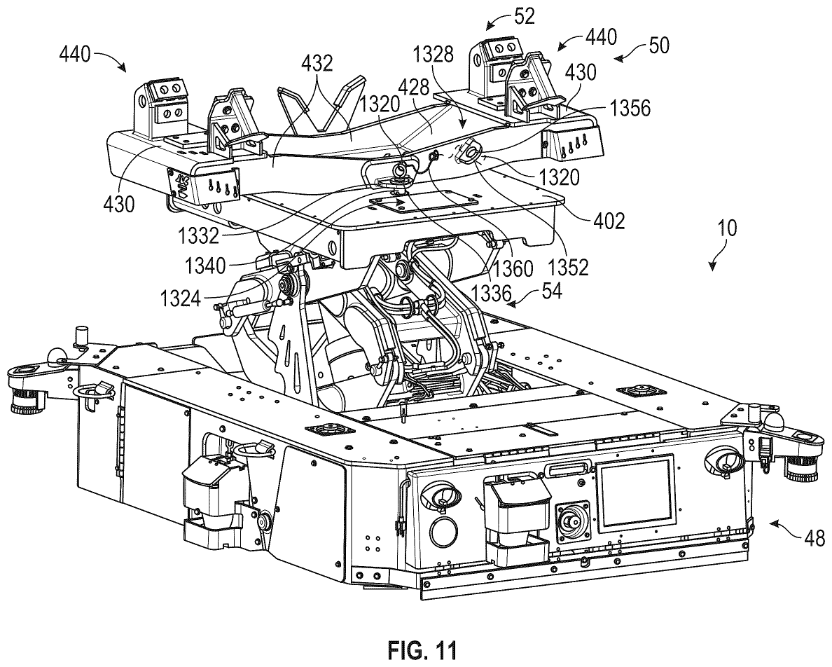

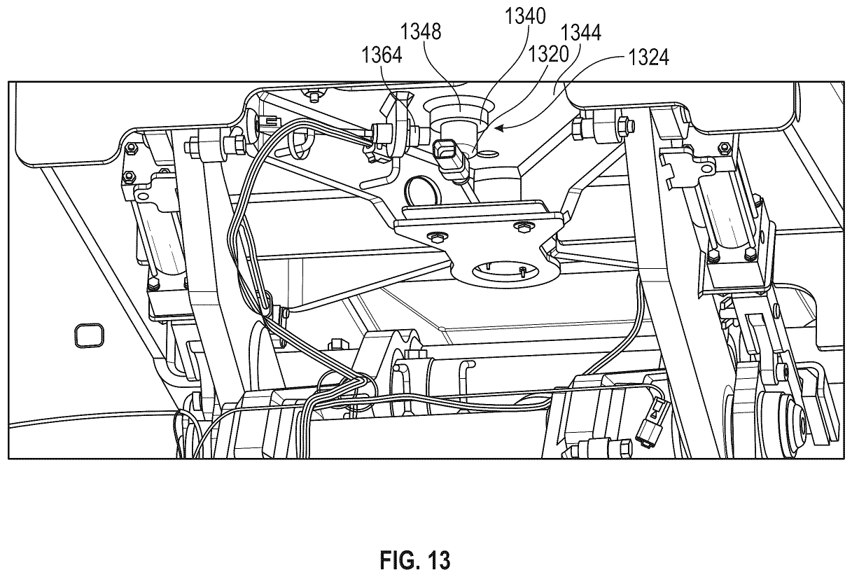

As shown in FIGS. 11 and 12, the vehicle 10 includes a rotation locking assembly including a locking pin (e.g., fastener, bolt, etc.), shown as pin 1320, that is movable between a locked position, shown as first position 1324, and an unlocked position, shown as second position 1328. In the first position 1324, the pin 1320 is received within (i) a first aperture, shown as first bracket aperture 1336, of a first bracket 1332, and (ii) a second aperture, shown as platform aperture 1340, of the top platform 402. The first bracket 1332 is coupled to and extends away from the cradle arm 432 closest to the front end portion of the vehicle 10. In other embodiments, the first bracket 1332 is positioned along the cradle arm 432 closest to the rear end portion of the vehicle 10. As shown in FIG. 13, a pin support (e.g., support member), shown as shoulder 1348, extends from a bottom surface 1344 of the top platform 402 and defines at least a portion of the platform aperture 1340 extending through the top platform 402. The shoulder 1348 is configured to circumferentially engage with a portion of the pin 1320 (e.g., when the pin 1320 is in the first position 1324) to support the pin 1320 and provide additional rigidity to the pin 1320. By way of example, when the pin 1320 is in the first position 1324 and a load is exerted on the pin 1320 (e.g., by the cradle base 428 and/or the top platform 402), the shoulder 1348 may reinforce the pin 1320 by distributing the load across the shoulder 1348 to prevent deformation of the pin 1320 under the load. In some embodiments, the top platform 402 does not include the shoulder 1348.

As shown in FIG. 11, the first bracket aperture 1336 extends through (e.g., vertically) the first bracket 1332, and, as shown in FIG. 13, the platform aperture 1340 extends through (e.g., vertically) the top platform 402. In the first position 1324, the pin 1320 is received in the first bracket aperture 1336 defined by the first bracket 1332 to engage with the cradle 52 and the platform aperture 1340 defined by the top platform 402 to engage with the top platform 402 such that rotation of the cradle 52 relative to the top platform 402 is inhibited. Specifically, in the first position 1324, the pin 1320 retains the cradle 52 in a position such that the pin 438 is substantially centered along the arc defined by the rotation slot 434 and the centerline 436 extends through the pin 438. In other words, in the first position 1324, the pin 1320 retains the cradle 52 such that the axle supported thereby is substantially perpendicular to a direction of travel of the vehicle 10 supporting the axle. In the first position 1324, rotation of the cradle 52 relative to the top platform 402 is inhibited such that the cradle 52 is rotationally fixed and inhibited from rotating in a first direction (e.g., clockwise) relative to the top platform 402 and in a second direction (e.g., counterclockwise) relative to the top platform 402.

In the second position 1328, the pin 1320 extends through a third opening, shown as second bracket opening 1356, defined by a second bracket 1352. As shown in FIGS. 11 and 12, the second bracket 1352 is coupled to and extends away from the cradle arm 432 closest to the front end portion of the vehicle 10. In other embodiments, the second bracket 1352 is positioned along the cradle arm 432 closest to the rear end portion of the vehicle 10. When the pin 1320 is in the second position 1328, rotation of the cradle 52 relative to the top platform 402 is permitted (e.g., not inhibited by the pin 1320) to facilitate steering the vehicle 10 in both directions (e.g., right and left). When the pin 1320 is in the second position 1328, the second bracket 1352 and the second bracket opening 1356 may secure the pin 1320 to prevent unintentional movement thereof when the pin 1320 is not in use. By way of example, when the pin 1320 is not in the first position 1324 such that rotation of the cradle 52 is permitted, the second bracket 1352 and the second bracket opening 1356 may secure the pin 1320 to prevent unintentional movement thereof during driving operations of the vehicle 10. In some embodiments, the vehicle 10 does not include the second bracket 1352 such that the pin 1320 is otherwise stored when not in the first position 1324. By way of example, the vehicle 10 may include a space (e.g., a pocket, a hook, a compartment, etc.) to store or otherwise secure the pin 1320 when not in use.

As shown in FIGS. 11 and 12, the vehicle 10 includes a tether (e.g., rope, string, cable, chain, strap, etc.), shown as cord 1360, coupled between the pin 1320 and the cradle arm 432 to which the first bracket 1332 and the second bracket 1352 are coupled. The cord 1360 may be manufactured from a flexible, pliable, bendable, etc., material to provide free movement of the pin 1320 (e.g., when the pin 1320 is not in the first position 1324) relative to the vehicle 10 (e.g., within a range defined by a length of the cord 1360). The cord 1360 is configured to prevent the pin 1320 from being lost or misplaced when it is not secured or stored in the first position 1324 or the second position 1328, respectively. In some embodiments, the vehicle 10 does not include the cord 1360.

When the cradle 52 is positioned (e.g., rotated) such that the first bracket aperture 1336 is aligned (e.g., vertically aligned, vertically coaxial, etc.) with the platform aperture 1340, the first bracket aperture 1336 and the platform aperture 1340 may cooperatively receive the pin 1320 (e.g., in the first position 1324) to inhibit rotation of the cradle 52. Similarly, in such a position, the pin 1320 may be removed from the first bracket aperture 1336 and the platform aperture 1340 out of engagement with the cradle 52 and the top platform 402 (e.g., by an operator) and placed in the second bracket opening 1356 to transition (e.g., move) the pin 1320 to the second position 1328. In some embodiments, the pin 1320 is otherwise moveable to transition between the first position 1324 and the second position 1328 (or another position that is not the first position 1324) to selectively permit rotation of the cradle 52 relative to the top platform 402. By way of example, the pin 1320 may be coupled with a solenoid configured to move the pin 1320 between the first position 1324 and the second position 1328 (or another position that is not the first position 1324). In some embodiments, the rotation locking assembly does not include the pin 1320 and uses another suitable mechanism to selectively permit rotation of the cradle 52 relative to the top platform 402. By way of example, the rotation locking assembly may include a lock (e.g., a pad lock) configured to lock in the first position 1324 or the second position 1328 (or another position that is not the first position 1324) such that an operator with access to the lock (e.g., an operator with a key to lock/unlock the lock, an operator with a password (e.g., pin, combination, etc.), etc.) can transition the lock between the first position 1324 and the second position 1328 (or another position that is not the first position 1324). By way of another example, the rotation locking assembly may include an electromagnetic lock configured to selectively magnetically couple the cradle 52 with the top platform 402. By way of another example, the rotation locking assembly may include a brake system configured to selectively induce a friction force between the cradle 52 and the top platform 402.

As shown in FIG. 13, the vehicle 10 includes a sensor 1364 configured to monitor a position of the pin 1320 and transmit a signal associated with information acquired to the control system 100. The sensor 1364 may include proximity sensors, motion sensors, position sensors (e.g., Hall effect sensors, limit switches, encoders, etc.), vision sensors, cameras, among others operatively coupled to the controller 102. The sensor 1364 may provide sensor data indicative of a position of the pin 1320 to the controller 102 to determine whether the pin 1320 is in the first position 1324 (and the rotation locking assembly is in a locked state) or the second position 1328 (and the rotation locking assembly is in an unlocked state). As shown in FIG. 13, the sensor 1364 is positioned along the bottom surface 1344 of the top platform 402 and configured to monitor whether the pin 1320 is extending through the platform aperture 1340. In some embodiments, the vehicle 10 includes a sensor 1364 (e.g., in addition to the sensor 1364 positioned along the bottom surface 1344) positioned and configured to monitor whether the pin 1320 is received in the first bracket aperture 1336 of the first bracket 1332. In other embodiments, a single sensor 1364 is configured to monitor whether the pin 1320 is received in one or both of the first bracket aperture 1336 and the platform aperture 1340. In some embodiments, the vehicle 10 includes a sensor 1364 positioned and configured to monitor whether the pin 1320 is received in the second bracket opening 1356 of the second bracket 1352 in the second position 1328.

According to an exemplary embodiment, the rotation locking assembly enables selectively permitting and inhibiting rotation of the cradle 52 relative to the top platform 402 for the first vehicle 10a and the second vehicle 10b to enable steering of the first vehicle 10a and the second vehicle 10b while supporting the telehandler 56. As described herein, the first vehicle 10a and the second vehicle 10b may support the telehandler 56 (e.g., during the manufacturing line process), and the front vehicle 10 of the first vehicle 10a or the second vehicle 10b may turn relative to the rear vehicle 10 of the other one of the first vehicle 10a or the second vehicle 10b via the drive motors 42 or a steering motor. The pin 1320 of the front vehicle 10 may be positioned in the second position 1328 (or another position not in the first position 1324) such that as the front vehicle 10 turns relative to the rear vehicle 10, the cradle 52, which supports the telehandler 56, of the front vehicle 10 may rotate relative to the top platform 402 of the front vehicle 10, and the pin 1320 of the rear vehicle 10 may be positioned in the first position 1324 such that as the front vehicle 10 turns relative to the rear vehicle 10, the cradle 52 is inhibited from rotating relative to the top platform 402 of the rear vehicle 10 and allow the two vehicles to turn (e.g., the two vehicles are not restricted to travel in a straight line). By way of example, when the first vehicle 10a is the front vehicle 10 and the second vehicle 10b is the rear vehicle 10, the pin 1320 of the first vehicle 10a may be in the second position 1328, and the pin 1320 of the second vehicle 10b may be in the first position 1324. By way of another example, when the second vehicle 10b is the front vehicle 10 and the first vehicle 10a is the rear vehicle 10, the pin 1320 of the second vehicle 10b may be in the second position 1328, and the pin 1320 of the first vehicle 10a may be in the first position 1324. In this manner, regardless of which vehicle 10 of the first vehicle 10a or the second vehicle 10b is the front vehicle 10 and which vehicle 10 of the first vehicle 10a or the second vehicle 10b is the rear vehicle 10, the pin 1320 is repositionable to selectively permit or inhibit rotation of the cradle 52 relative to the top platform 402 depending on the arrangement of the vehicles 10.

According to an exemplary embodiment, to transition from a first configuration in which the first vehicle 10a is the front vehicle 10 and the second vehicle 10b is the rear vehicle 10 to a second configuration in which the second vehicle 10b is the front vehicle 10 and the first vehicle 10a is the rear vehicle 10, the pin 1320 of the first vehicle 10a is transitioned (e.g., moved) from the second position 1328 to the first position 1324 (e.g., removed from the second bracket opening 1356 and received in the first bracket aperture 1336 and the platform aperture 1340) and the pin 1320 of the second vehicle 10b is transitioned from the first position 1324 to the second position 1328 (e.g., removed from the first bracket aperture 1336 and the platform aperture 1340 and received in the second bracket opening 1356). Similarly, to transition from the first configuration to the second configuration, the pin 1320 of the first vehicle 10a is transitioned from the first position 1324 to the second position 1328 and the pin 1320 of the second vehicle 10b is transitioned from the second position 1328 to the first position 1324. In some embodiments, transitioning between the first configuration and the second configuration is advantageous in certain operational scenarios in which it is difficult or impossible (e.g., due to space constraints) to transition the front vehicle 10 (e.g., turn the front vehicle 10 and the rear vehicle 10 supporting the telehandler 56) from traveling in a first direction to traveling in a second direction opposite the first direction while remaining in one of the first configuration or the second configuration. By way of example, if the first vehicle 10a is the front vehicle 10 traveling in a first direction along the manufacturing line 156 between the stations 160 and then needs to travel in a second direction along the manufacturing line 156 (e.g., to a previous stations 160 or another stations 160, after delivering a first telehandler 56 and receiving a second telehandler 56, etc.), instead of turning the first vehicle 10a and the second vehicle 10b supporting the telehandler 56 around such that the first vehicle 10a remains the front vehicle 10, the rotation lock assembly enables transitioning from the first configuration to the second configuration such that the second vehicle 10b becomes the front vehicle 10 and can travel in the second direction along the manufacturing line 156. In some embodiments, the vehicle system includes a single pin 1320 for the rotation locking assemblies of the first vehicle 10a and the second vehicle 10b. By way of example, in the first configuration, the single pin 1320 may be in the first position 1324 at the first vehicle 10a, and in the second configuration, the single pin 1320 may be in the first position 1324 at the second vehicle 10b.

According to an exemplary embodiment, based on the sensor data indicating that the pin 1320 is extending through the first bracket aperture 1336 and the platform aperture 1340, the controller 102 determines that the pin 1320 is in the first position 1324 and that rotation of the cradle 52 relative to the top platform 402 is inhibited. In some embodiments, when the sensor data indicates that the pin 1320 is extending through one of the first bracket aperture 1336 or the platform aperture 1340 and not the other (e.g., the pin 1320 is extending through the first bracket aperture 1336 and not through the platform aperture 1340) or is otherwise improperly received in the first bracket aperture 1336 or the platform aperture 1340, the controller 102 determines that the pin 1320 is not in the first position 1324 and that rotation of the cradle 52 relative to the top platform 402 may be unintentionally permitted. In some embodiments, when the sensor data indicates that the pin 1320 is extending through the second bracket opening 1356, the controller 102 determines that the pin 1320 is in the second position 1328 and that rotation of the cradle 52 relative to the top platform 402 is permitted.

According to an exemplary embodiment, in response to the determination that the pin 1320 of the front vehicle 10 is in the second position 1328 and that the pin 1320 of the rear vehicle 10 is in the first position 1324, the controller 102 facilitates normal, unrestricted operation of the front vehicle 10 and the rear vehicle 10 (e.g., permits operation of the front vehicle 10 and the rear vehicle 10 in a first mode of operation). By way of example, in the first mode of operation, the controller 102 may permit normal, unrestricted operation of the drivetrain 40, the base assembly 48, the lifting implement 50, and/or any other component of the first vehicle 10a and the second vehicle 10b (e.g., the front vehicle 10 and the rear vehicle 10). In some embodiments, in response to a determination that (i) the pin 1320 of the front vehicle 10 is not in the second position 1328 (e.g., in the first position 1324, hanging from the cradle arm 432 by the cord 1360, improperly received in the first bracket aperture 1336 or the platform aperture 1340, etc.) and/or (ii) the pin 1320 of the rear vehicle 10 is not in the first position 1324 (e.g., in the second position 1328, hanging from the cradle arm 432 by the cord 1360, improperly received in the first bracket aperture 1336 or the platform aperture 1340, etc.), the controller 102 (i) limits operation of the front vehicle 10 and/or the rear vehicle 10 (e.g., in a second mode of operation) and/or (ii) provides an alert (e.g., visually or audibly via the user interface 114) indicative of an improper position of the pin 1320 of the front vehicle 10 and/or the rear vehicle 10. By way of example, in the second mode of operation, the controller 102 may (i) limit operation of the drive motors 42 such that the first vehicle 10a and/or the second vehicle 10b cannot exceed a threshold speed (e.g., 5 miles per hour, 2 miles per hour, 0 miles per hour, etc.), (ii) limit operation of the lift assembly 54 such that the lifting implement 50 cannot be raised or lowered, and/or (iii) any other control to limit operation of the first vehicle 10a and/or the second vehicle 10b. The first vehicle 10a and/or the second vehicle 10b may be limited to the second mode of operation until the pin 1320 of the front vehicle 10 is in the second position 1328 and the pin 1320 of the rear vehicle 10 is in the first position 1324.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle system comprising:
a first vehicle including:
a first chassis;
a first plurality of tractive elements coupled to the first chassis, the first plurality of tractive elements configured to engage a ground surface to support the first vehicle;
a first drive motor configured to drive one or more of the first plurality of tractive elements to propel the first vehicle; and
a first cradle configured to support a product at a first end thereof for movement; and
a second vehicle including:
a second chassis;
a second plurality of tractive elements coupled to the second chassis, the second plurality of tractive elements configured to engage the ground surface to support the second vehicle;
a second drive motor configured to drive one or more of the second plurality of tractive elements to propel the second vehicle; and
a second cradle configured to support the product at a second end thereof for movement;
wherein the first vehicle and the second vehicle move the product via at least one of the first drive motor or the second drive motor.

2. The vehicle system of claim 1, wherein the first cradle is rotatable relative to the first chassis and the second cradle is rotatable relative to the second chassis.

3. The vehicle system of claim 2, wherein the first vehicle includes a first rotation locking assembly selectively transitionable between a first state in which rotation of the first cradle relative to the first chassis is inhibited and a second state in which rotation of the first cradle relative to the first chassis is permitted, and wherein the second vehicle includes a second rotation locking assembly selectively transitionable between a first state in which rotation of the second cradle relative to the second chassis is inhibited and a second state in which rotation of the second cradle relative to the second chassis is permitted.

4. The vehicle system of claim 3, wherein, in a first configuration of the vehicle system, the first vehicle is a front vehicle and the first rotation locking assembly is in the second state, and the second vehicle is a rear vehicle and the second rotation locking assembly is in the first state.

5. The vehicle system of claim 4, wherein the vehicle system is selectively transitionable from the first configuration to a second configuration in which the first vehicle is the rear vehicle and the first rotation locking assembly is in the first state, and the second vehicle is the front vehicle and the second rotation locking assembly is in the second state.

6. The vehicle system of claim 5, further comprising one or more processing circuits configured to:
monitor a state of the first rotation locking assembly and the second rotation locking assembly; and
permit operation of the first vehicle and the second vehicle in a first mode of operation in response to a determination that (i) the first rotation locking assembly or the second rotation locking assembly of the front vehicle is in the second state and (ii) the other one of the first rotation locking assembly or the second rotation locking assembly of the rear vehicle is in the first state.

7. The vehicle system of claim 6, wherein the one or more processing circuits are configured to limit operation of at least one of the first vehicle or the second vehicle in a second mode of operation in response to a determination that at least one of (i) the first rotation locking assembly or the second rotation locking assembly of the front vehicle is not in the second state or (ii) the other one of the first rotation locking assembly or the second rotation locking assembly of the rear vehicle is not in the first state.

8. The vehicle system of claim 3, wherein the first vehicle includes a first platform configured to be raised and lowered relative to the first chassis, the first cradle rotatably coupled to the first platform, and wherein the second vehicle includes a second platform configured to be raised and lowered relative to the second chassis.

9. The vehicle system of claim 8, wherein:
the first platform defines a first platform aperture;
the second platform defines a second platform aperture;
the first rotation locking assembly includes a first pin and a first bracket extending from the first cradle, the first bracket defining a first bracket aperture;
the second rotation locking assembly includes a second pin and a second bracket extending from the second cradle, the second bracket defining a second bracket aperture; and
in the first state, the first pin is received in the first bracket aperture and the first platform aperture to inhibit rotation of the first cradle relative to the first platform, and the second pin is received in the second bracket aperture and the second platform aperture to inhibit rotation of the second cradle relative to the second platform.

10. The vehicle system of claim 9, wherein:
the first rotation locking assembly includes a third bracket extending from the first cradle, the third bracket defining a third bracket aperture;
the second rotation locking assembly includes a fourth bracket extending from the second cradle, the fourth bracket defining a fourth bracket aperture; and
in the second state, the first pin is received in the third bracket aperture to permit rotation of the first cradle relative to the first platform, and the second pin is received in the fourth bracket aperture to permit rotation of the second cradle relative to the second platform.

11. The vehicle system of claim 9, wherein the first pin and the second pin are manually movable to transition the vehicle system between a first configuration and a second configuration.

12. The vehicle system of claim 11, wherein the first pin is movably coupled to the first cradle by a first tether, and wherein the second pin is movably coupled to the second cradle by a second tether.

13. The vehicle system of claim 1, wherein the first vehicle includes a first body supported by the first chassis, the first body having a first side defining a first length from the first cradle and a second side defining a second length less than the first length from the first cradle, wherein the second vehicle includes a second body supported by the second chassis, the second body having a first side defining a first length from the second cradle and a second side defining a second length less than the first length from the second cradle, and wherein, when supporting the product, the first vehicle is oriented in a first direction and the second vehicle is oriented in a second direction opposite the first direction such that the first side of the first vehicle and the first side of the second vehicle are positioned away from a space between the first vehicle and the second vehicle.

14. The vehicle system of claim 13, wherein the first vehicle includes a first user interface positioned along the first side of the first vehicle, and wherein the second vehicle includes a second user interface positioned along the first side of the second vehicle.

15. The vehicle system of claim 1, wherein the first vehicle is in communication with the second vehicle.

16. A method of transporting a product, the method comprising:
providing a first vehicle including a first chassis and a first cradle configured to support the product for movement, the first cradle rotatable relative to the first chassis;
providing a second vehicle including a second chassis and a second cradle configured to support the product for movement, the second cradle rotatable relative to the second chassis;
placing a pin in a second aperture defined by the second cradle such that rotation of the second cradle relative to the second chassis is inhibited; and
controlling at least one of the first vehicle or the second vehicle to transport the product in a first direction;
wherein, when the pin is placed in the second aperture, the first vehicle and the second vehicle are in a first configuration in which the first vehicle is a front vehicle and the second vehicle is a rear vehicle.

17. The method of claim 16, further comprising:
removing the pin from the second aperture; and
placing the pin in a first aperture defined by the first cradle such that rotation of the first cradle relative to the first chassis is inhibited and rotation of the second cradle relative to the second chassis is permitted;
wherein removing the pin from the second aperture and placing the pin in the first aperture transitions the first vehicle and the second vehicle from the first configuration to a second configuration in which the second vehicle is the front vehicle and the first vehicle is the rear vehicle.

18. The method of claim 17, wherein the product is a first product, and wherein the method further comprises:
removing the first product from being supported by the first cradle and the second cradle;
supporting, by the first cradle and the second cradle, a second product; and
controlling at least one of the first vehicle or the second vehicle to transport the second product in a second direction opposite the first direction when the first vehicle and the second vehicle are in the second configuration.

19. A vehicle system comprising:
two vehicles, each vehicle including:
a chassis;
a plurality of tractive elements coupled to the chassis, the plurality of tractive elements configured to engage a ground surface to support the vehicle;
a drive system configured to drive one or more of the plurality of tractive elements to propel the vehicle and steer one or more of the plurality of tractive elements to steer the vehicle;
a platform defining a platform aperture;
a cradle configured to support a respective end of a product for movement, the cradle rotatably coupled to the platform;
a bracket coupled with the cradle and defining a bracket aperture; and
a pin configured to be received in the platform aperture and the bracket aperture to inhibit rotation of the cradle relative to the platform; and
one or more processing circuits configured to:
monitor a position of the pin; and
control the drive system of at least one of the two vehicles based on the position of the pin;
wherein the two vehicles are configured to transition between a first configuration and a second configuration by moving the pin out of the platform aperture and the bracket aperture of a first vehicle of the two vehicles and into the platform aperture and the bracket aperture of a second vehicle of the two vehicles.

20. The vehicle system of claim 19, wherein, in the first configuration, the one or more processing circuits are configured to control the drive system of at least one of the two vehicles to transport the product in a first direction, and wherein, in the second configuration, the one or more processing circuits are configured to control the drive system of at least one of the two vehicles to transport the product in a second direction.
